(19) United States
(12) Patent Application Publication
(10) Pub. No.: US 2007/0133654 A1
(43) Pub. Date: Jun. 14, 2007

(54) Liquid temperature detectors

(76) Inventor: Debra Fogel Harris, Boca Raton, FL (US)

Correspondence Address: JUAN C. VILLAR, 9365 AEGEAN DRIVE, BOCA RATON, FL, 33496, US

(21) Appl. No.: 11/650,910

(22) Filed: Jan. 6, 2007

Related U.S. Application Data
(63) Continuation-in-part of application No. 11/322,005, filed on Dec. 29, 2005.
Application No. 11/322,005 is a continuation-in-part of application No. 11/274,576, filed on Nov. 15, 2005, now abandoned.
(60) Provisional application No. 60/708,252, filed on Aug. 15, 2005.
(60) Provisional application No. 60/593,276, filed on Jan. 3, 2005.
(60) Provisional application No. 60/522,862, filed on Nov. 15, 2004.

(51) Int. Cl. G01J 5/00; G01K 1/14; G01K 13/00

(52) U.S. Cl. 374/121; 374/155; 374/141

(57) ABSTRACT

Disclosed are devices and methods for measuring the temperature of a liquid in a container, the device either having a temperature sensor for measuring the temperature of the outer surface of the container, a probe for directly measuring the contents of the container, or an IR detector for measuring IR radiation passing, through, re-emitted by, and emitted by the container. The device may be in the form of a corkscrew, bottle opener, pen, or simple casing. The temperature reading may be outputted to the user audibly and/or visually, such as with an LCD display. In one embodiment, there are mounted a plurality of indicator lamps, each lamp representing a particular type of liquid, a control for selecting the type of liquid whose temperature is to be measured, an infrared detector, an output indicating to the user whether the temperature of the liquid is above or below a predetermined temperature range.

### RELATED APPLICATIONS

This patent application is a continuation-in-part of U.S. patent application Ser. No. 11/322,005, of identical title, filed Dec. 29, 2005, which in turn is a continuation in part of U.S. patent application Ser. No. 11/274,576, of identical title, filed Nov. 15, 2005, which in turn claims the benefit of U.S. provisional patent application Ser. Nos. 60/708,252, filed Aug. 15, 2005; 60/593,276, filed Mar. 1, 2005; and 60/522,862, filed Nov. 15, 2004, the disclosures of all of which are incorporated by reference herein in their entirety. This application also claims the benefits of U.S. provisional patent application Ser. No. 60/593,276, filed Jan. 3, 2005, the disclosures of which are incorporated by reference herein in their entirety.

### BACKGROUND OF THE INVENTION

1. Technical Field

The present invention relates to liquid temperature detectors in the form of probes and/or infrared sensors used in combination with audio and/or visual output devices to indicate to the user whether the liquid within a container, such as wine or other liquid in a bottle, or water or beer in a pitcher, is too warm or too cold for optimal consumption.

The present invention also relates to integrating such liquid temperature detectors into common household items, such as corkscrews and bottle openers.

2. Background Art

There is a large segment of the population who enjoy wine on a regular basis with meals, and at social occasions. To best enjoy a particular type of wine, it should be served within a temperature range suitable for that wine. For example, sparkling wines such as champagne are typically served cold, white wines are typically served slightly warmer, young red and red wines are served warmer than white wines, and special wines such as sherry or port are served warmer than red wines.

A disadvantage associated with the enjoyment of wine is that the consumer may not know the proper temperature for the particular wine the consumer plans to drink. Wine producers have attempted to assist consumers by printing the best temperature on wine labels. This simple step informs the consumer of the correct temperature for consumption, but the consumer must still determine what the actual temperature of the wine is.

One attempt to improve upon the mere listing of the correct temperature has been to adhere a thermal strip thermometer to the side of the wine bottle. This allows a direct readout of the temperature of the wine. While this approach is convenient when preparing to drink the wine, it also has several disadvantages. One such disadvantage is the cost associated with attaching the thermal strip thermometer to the side of the wine bottle which is then discarded with the bottle. An additional drawback to this approach is that either the manufacturer, the merchant, or the consumer must bear the time, effort and expense involved with purchasing, stocking, and applying the thermal strip thermometers. It would be desirable to have a convenient and reusable method of determining the temperature of the wine prior to consumption.

It would also be desirable to provide a convenient and entertaining method of informing the consumer that the wine is at the correct temperature. By having a temperature indication system which is also entertaining, consumers are more likely to use it. In addition, the user would receive greater enjoyment from the wine by receiving training in what the proper temperature of that particular wine should be.

One method of measuring wine temperature is to insert a temperature measurement probe through the cork and into the wine. One drawback to known probes is that they tend to be very narrow and fragile. As a result, they are very easily broken. Due to the fragility of known probe devices, individuals such as waiters, who frequently open wine bottles, would not wish to use this type of device because the substantial risk of breakage. In addition, having the probe constantly exposed will decrease the ability to maintain cleanliness. Further, the probe also raises a safety issue depending on how sharp its tip is. It would be desirable to have a method of using a probe to measure wine temperature without the disadvantages associated with known probe devices.

While addressing the basic desirability of drinking wine at the proper temperature, the prior art has failed to provide a convenient reusable device, which is can be reduced in size when not in use, which can enclose the temperature probe for safety, cleanliness and convenience, which is inexpensive to manufacture, which provides a variety of information to the consumer, which encourages its use, which provides entertainment to the consumer when it is used, and which allows an individual to ascertain the temperature of the wine inside the bottle without opening the bottle.

Further, it would be desirable to measure the temperature of a liquid in a container without physical intrusion of the container itself.

### SUMMARY OF THE INVENTION

Disclosed is a method for measuring the temperature of a liquid within a container, the method comprising placing an infrared detector in close proximity to the outer walls of the container and measuring the amount of infrared radiation transmitted through and radiated therefrom.

Disclosed is an apparatus for measuring the temperature of a liquid in a container, the apparatus having an elongate casing upon which are mounted a plurality of indicator lamps, each lamp representing a particular type of liquid, a control for selecting the type of liquid whose temperature is to be measured, an infrared detector, an output indicating to the user whether the temperature of the liquid is above or below a predetermined temperature range.

Also disclosed is an intelligent wine temperature probe for use with wine bottles having an external case having a temperature indication output means, an internal cavity, a retractable wine temperature probe, the retractable wine temperature probe sized such that it fits within the internal cavity, and slideably attached to the external case such that it can be extended outside of the external case or retracted into the external case, the retractable wine temperature probe further capable of being inserted into the neck of a wine bottle or penetrated through a cork in the wine bottle, a temperature sensor in the wine temperature probe, means to output the temperature detected by the temperature sensor, and whereby the wine temperature probe outputs information related to the temperature of wine inside the bottle.

### BRIEF DESCRIPTION OF THE DRAWINGS

FIG. 1 is a front view of a corkscrew embodiment of the invention in the closed position.

FIG. 2 is a rear view of a corkscrew embodiment in the closed position.

FIG. 3 is a right side view of a corkscrew embodiment in the closed position.

FIG. 4 is a left side view of a corkscrew embodiment in the closed position.

FIG. 5 is a front side view of a corkscrew embodiment with the corkscrew, and the lever arm with integral thermometer, in the open position.

FIG. 6 is a right side view of a corkscrew embodiment with the corkscrew, and the lever arm with integral thermometer, in the open position. The lever arm with integral thermometer is shown touching a bottle to measure the temperature. The bottle is not part of the design.

FIG. 7 is a left side view of a corkscrew embodiment with the corkscrew, and the lever arm with integral thermometer, in the closed position, and the cutting blade in the open position.

FIG. 8 is a distal end view of a corkscrew embodiment.

FIG. 9 is a proximal end view of a corkscrew embodiment.

FIG. 10 is a front side view of another corkscrew embodiment. This embodiment does not have a recording option.

FIG. 11 is a front side view of another corkscrew embodiment. This embodiment does not have a recording option or a speaker option.

FIG. 12 is a front side view of another alternative embodiment which eliminates the optional audio components and the optional bottle cap removal. The temperature sensor is located on the body of the corkscrew rather than the lever arm.

FIG. 13 is a rear side view of the alternative embodiment of FIG. 12 which eliminates the optional magnet, and the optional bottle cap remover. The temperature sensor is located on the body of the corkscrew rather than the lever arm.

FIG. 14 is a front view of a preferred embodiment of a liquid temperature probe which illustrates the probe in the extended position.

FIG. 15 is a front view of a preferred embodiment of a liquid temperature probe which illustrates the probe in the retracted position.

FIG. 16 is a front view of an alternative preferred embodiment of a liquid temperature probe which includes an optional temperature meter.

FIG. 17 is a front transparent view that illustrates an alternative embodiment of a liquid temperature probe which includes an optional retractable corkscrew in the retracted position.

FIG. 18 is a front transparent view of an alternative embodiment of a liquid temperature probe that includes an optional retractable corkscrew in the extended position.

FIG. 19 is a front transparent view of an alternative embodiment of a liquid temperature probe that illustrates an optional infrared temperature sensor.

FIGS. 20a and 20b are front plan and top plan views, respectively, of a basic pen embodiment of the invention.

FIGS. 21a and 21b are front plan and top plan views respectively of a pen embodiment of the invention that includes sound output. FIG. 21c is a side plan view of the microphone controls of the embodiment.

FIG. 22 is a front plan view of the pen embodiment of FIG. 21 that includes a no-slip grip.

FIG. 23 is a perspective view of a rectangular wand embodiment of the invention that includes an LCD display and separate read temperature control.

FIG. 24 is a perspective view of a cylindrical wand embodiment of the invention that includes multiple features and a side IR port.

FIGS. 25a and 25b show corkscrew embodiments having a digital display.

FIG. 26 is a perspective view of yet another corkscrew embodiment of the invention.

### DETAILED DESCRIPTION OF THE INVENTION

This specification incorporates herein by reference the disclosures of U.S. Pat. No. 6,536,306, issued Mar. 25, 2003, in its entirety.

Prior to a detailed discussion of the figures, a general overview of the features and advantages of the invention will be presented. The present invention provides the ability to measure wine temperature without removing the cork from the wine bottle while giving an accurate reading of the wine inside the sealed bottle. In particular, a liquid temperature probe is provided that uses one or more technologies to measure wine temperature inside a bottle.

An embodiment of the invention provides a retractable wine temperature probe that pierces the cork in a wine bottle to directly measure wine temperature or, if the bottle is already opened, may be inserted into the bottle opening. There are known probes which measure wine temperature in this manner. However, they are fixed probes which permanently extend from a housing or outer case. Unfortunately, the fixed structure of these devices has several disadvantages. First, prior art probes are typically thin and fragile. Because the probe is permanently extended from the probe case, it runs a constant risk of damage due to mishandling. Second, it also creates a safety hazard because the pointed end of the probe is always exposed. Third, it is inconvenient to carry because the extended length of the probe makes it too large to carry in a user's pocket. Fourth, having the probe constantly extended is unsanitary and creates a situation where the probe may be contaminated by numerous environmental factors. Of course, because the probe may come in physical contact with the wine, any contaminants on the probe may be transferred to the wine.

Another embodiment of the invention provides an infrared (IR) detector conveniently encased in a wand, pen, bottle opener, or other wandlike device that may simply be clipped to a shirt pocket, thereby making it easy for restaurant or wine dealer staff to carry it about on their persons at all times.

An infrared (IR) detector will read the surface temperature of a bottle or other container in addition to the temperature of the liquid contained therein, based upon the IR radiation emitted from the liquid that passes through the container walls and IR radiation absorbed by and re-emitted by the container walls. Interestingly, the color of the glass used to manufacture wine bottles has been found to have little or no influence on an IR temperature reading of the temperature of the liquid therein, most likely because pigments are generally transparent to IR radiation at most frequencies. Glass absorbs most long wave IR radiation, but then is prone to re-emit it. Hence the IR emission of the liquid inside the bottle directly and indirectly affects the IR emitted at the outer glass surface of the bottle and permits a more accurate reading than traditional temperature measuring sensors, such as thermistors, that rely only on thermal conduction. There is some variation caused by the thickness of the glass, however so the user will generally take a reading around the center of the bottle or higher because the glass of a wine bottle is usually thicker toward the bottom of the bottle. In any event it is desirable to allow about 15 minutes for thermal equilibrium to be established between the glass container and the liquid contents. For a wine bottle that has been cooling in a refrigeration unit or on ice for at least that time, this poses no problem. If however, the liquid is recently poured into a glass container at differing temperature, then it is desirable to await thermal equilibrium or, if the container opening permits, to take a reading directly from the exposed surface of the liquid soon after pouring.

Plastic containers are generally transparent to IR radiation at most frequencies and therefore permit immediate IR temperature measurement with minimal or no need for awaiting thermal equilibrium between the liquid and the container.

Bottle side thicknesses typically range from 50,000th of an inch (1.27 mm) to 150,000th of an inch (3.810 mm)

Champagne bottles are the thickest at approximately 0.25 in. When a bottle at ambient temperature (70 F) is chilled in cold water (55 F.), first the glass will cool. Because heat flows toward cold, the glass draws the heat out of the liquid in the bottle, and the liquid will equalize with the bottle temperature. Due to the thermal conductivity of glass, it will typically take approximately 15 minutes for the temperature equalization to occur. Temperature can also be measured by using time. Every material has radiation temperature, heat or lack of heat. Heat transfers are an effective way to measure temperature. Heat transfer between ice and the bottle are faster than air to bottle due to the higher density of the ice. By using the heat transfer times, an IR radiometer can be used to computer the temperature of a sealed bottle of wine.

IR is normally used to read surface temperature. This will result in the surface temperature of the outside the bottle being measured. However, IR can a so be used to read either bottle surface temperature and/or internal liquid temperature based on the IR frequency selected. When reading temperatures inside the bottle, short wavelengths will pass through the glass wall of the bottle at specific frequency wavelengths. In particular, IR frequency wavelengths at 0.7 to 0.4 microns can be used to read internal liquid temperature.

Test measurements were obtained using several sealed bottles of wine that were chilled with varying methods and to specific predetermined temperatures. The test used the outside of the wine bottles at indicated points over a period of charted time. When the bottle reached optimal drinking temperature the bottle was then opened and wine as poured into a glass. Using a liquid thermometer to measure wine would determine if the IR readings taken outside of the bottle were consistent with the true temperature of the wine inside. Testing the wine inside the glass with liquid thermometer, using IR outside the glass as well as IR pointed at the wine inside the glass was successful in displaying consistent and accurate temperature. The liquid was the same temperature as in the bottle within a few degrees or less. The central portion of the bottle was found to be the most accurate measurement location. This is because the central portion of the bottle has the greatest mass of liquid and is less susceptible to temperature fluctuations which would occur in narrow channels, such as the neck of the bottle.

In summary, when IR frequencies suitable for measuring through glass are used, IR will allow the temperature sensor to detect an accurate reading of the temperature inside a sealed bottle of liquid, such as wine, by measuring the temperature of the bottle surface and the IR radiation emitted by the wine that passes through or is re-emitted by the glass. This is a significant improvement over the prior art in that the temperature can be determined without disturbing the contents of the wine bottle or breaking the seal. When the temperature reaches optimal drinking temperature for selected a wine type, the user can be notified in any convenient manner, such as with a recorded message or visual indication. The temperature sensor can also be used after the bottle is opened and the wine is poured by pointing at the wine remaining inside the bottle to see if it needs to be placed back into the ice bucket. The IR thermometer may be designed to indicate the detected temperature in both Fahrenheit and Celsius. Of course, these principles apply to any contained liquid, not just wine.

The average temperature for a wine cellar should be 55 degrees plus or minus a few degrees (e.g., 53-57 degrees Fahrenheit) all wines, reds, whites, ports, etc., can be stored at this temperature. In contrast, the average temperature setting for a refrigerator is typically set to 36-42 degrees Fahrenheit. As a result, an individual will typically not drink wine immediately after taking the wine bottle out of the refrigerator. Rather, it is allowed to warm up to the proper drinking temperature. The ability to measure the wine temperature inside the bottle allows the user to delay opening the bottle until the wine is actually ready to drink.

When comparing wine at various temperatures, the following observations can be made about white wine:

At 34 degrees F.—straight from the ice bucket. At 34 degrees F., the white wine loses complexity and is too cold. In fact, it will usually taste like cold fruit juice.

At 50 degrees F.—from a wine cooler set to chill white wine between 50 degrees F. and 55 degrees F. —a chilled bottle set out for about an hour. White wine is most enjoyable when served at a temperature between 50 to 55 degrees F.

At 72 degrees F., room temperature, the wine is too warm to be enjoyed.

Care should be taken not to warm wine up too much, because there is a point of no return when the wine is damaged. Also, you cannot easily rechill wine when it is already poured into the wineglass.

Typical optimal temperatures for various types of wines are as follows:

Port: 65° F. to 70° F. (18° C. to 21° C.)

Red: 60° F. to 65° F. (16° C. to 18° C.)

Young Red: 55° F. to 60° F. (13° C. to 16° C.)

White: 50° F. to 55° F. (10° C. to 13° C.)

Rose: 45° F. to 50° F. (7° C. to 10° C.)

Champagne: 38° F. to 45° F. (3° C. to 7° C.)

It should be noted that the invention is not to be limited to the above ranges because opinions on temperature ranges for various types of wine can vary by as much as five degrees. In providing the invention to various customers, it may be necessary to vary the ranges according to the customer's express opinion or even nation or region of origin. The above temperature ranges should therefore be considered merely as typical or average.

To let a wine “breathe” means to expose it to air. However, this may change the flavor of a wine, but not necessarily for the better. The theory is that air can mellow the tannic or astringent quality in some types of wines. Typically, age is what mellows these flavors. The only wine that really needs to breathe are “dry reds” that are meant to be aged for many years before serving. Knowing what the temperature is inside the bottle provides the user with the ability to better control the amount of time they want the wine to breathe by getting the wine to the right temperature before opening the bottle.

IR is effective and accurate providing that particular frequency bands are used Test results indicate that frequency specific IR sensors (long wave IR spectrum) will provide an accurate reading of wine inside the bottle. It can also provide the user with a personal choice of allowing aged wine to breathe.

Corkscrew Embodiments

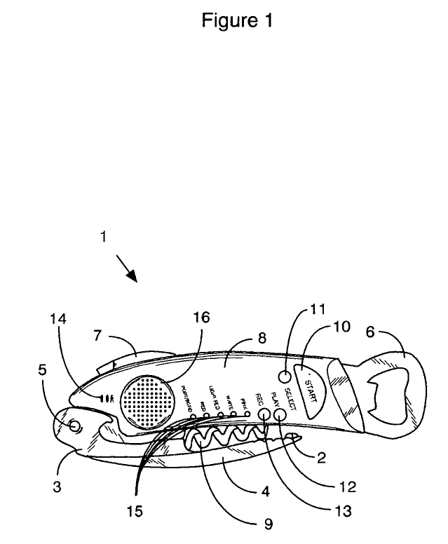

Referring to FIG. 1, this figure shows a front side view of a preferred embodiment of the corkscrew 1 is shown which has a temperature sensor 2 attached to the end of the lift lever extension 4 on the lift lever 3. The lift level 3 is attached via pivot pin 5 to handle 8. A bottle opener 8 is located on the proximinal end of the corkscrew 1, and a cutting blade 7 is located on the side edge of corkscrew 1. The cork removal screw 9 is shown in the folded position. A start button 10 is used to activate the battery operated device. Select button 11 is used in conjunction with play and record buttons 12 and 13 to control recording and playback of messages. Messages are recorded with microphone 14 and played back via speaker 16. LED indicators 15 are activated, based on the bottle temperature sensed by temperature sensor 2 to indicate the appropriate wine for that temperature. The corkscrew 1 can also play an audio message describing the correct temperature for a given wine.

In the preferred embodiment, the temperature sensor 2 uses infrared technology to sense the temperature of the wine in the bottle. However, those skilled in the art will recognize that any suitable technology can be used. For example, thermistors can be substituted for the infrared temperature sensors 2 used in the preferred embodiment.

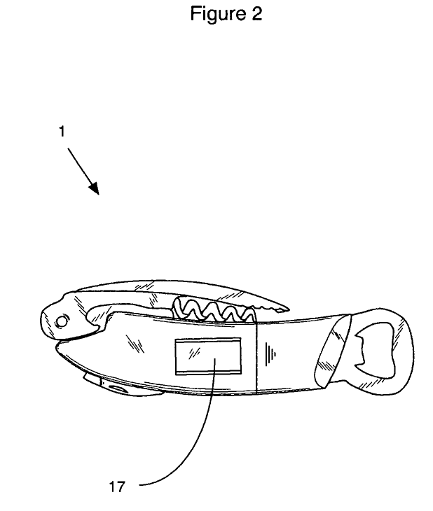

In FIG. 2, the rear side of the preferred embodiment of FIG. 1 is shown. This figure illustrates a magnet 17 which allows the device to be held by a metal surface, such as a refrigerator door.

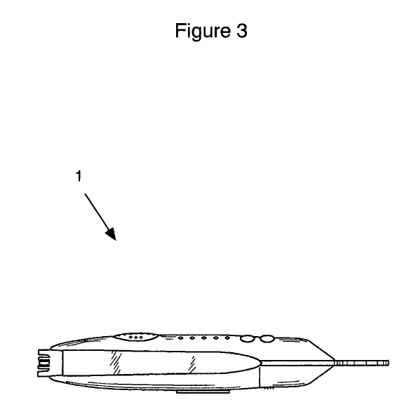

FIG. 3 is a right side view of a preferred embodiment of the corkscrew 1 with Integral Intelligent Thermometer in the closed position.

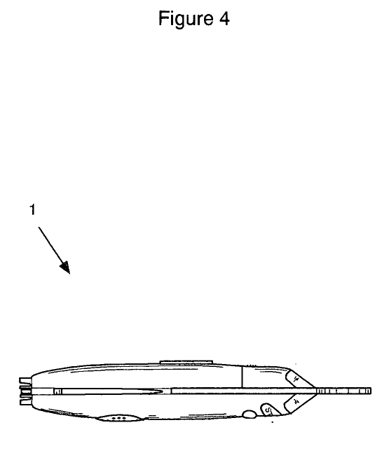

FIG. 4 is a left side view of a preferred embodiment of the corkscrew 1 with Integral Intelligent Thermometer in the closed position.

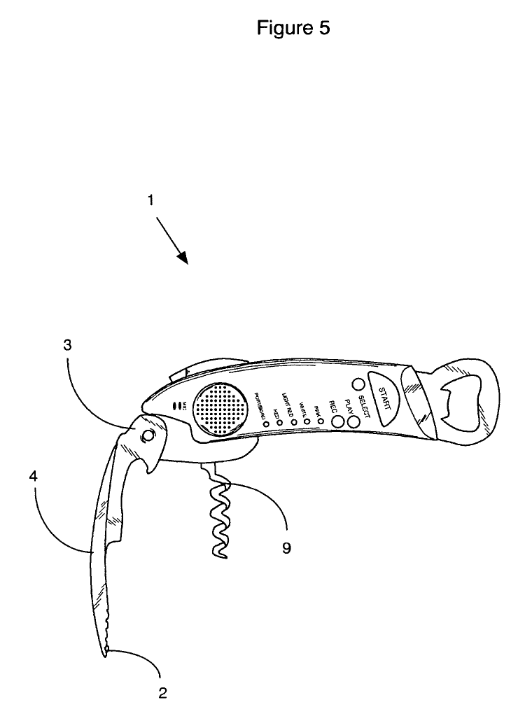

FIG. 5 is a front side view of a preferred embodiment of the corkscrew 1 with Integral Intelligent Thermometer with the corkscrew, and the lever arm 4 with integral thermometer 2, in the open position.

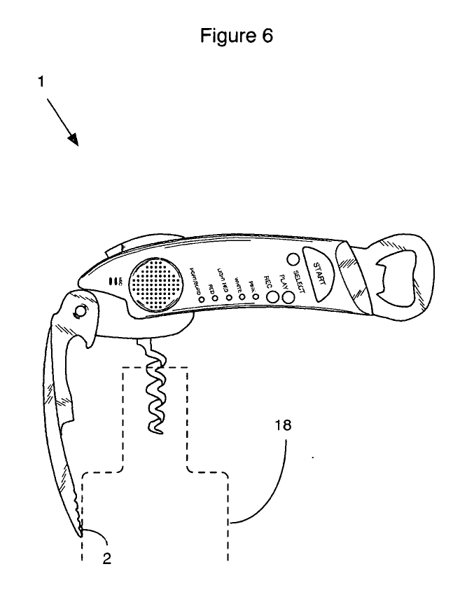

FIG. 6 is a right side view of a preferred embodiment of the corkscrew 1 with Integral Intelligent Thermometer with the corkscrew 1, and the lever arm 4 with integral temperature sensor 2, in the open position. The lever arm 4 with integral temperature sensor 2 is Shown touching a bottle 18 to measure the temperature. The bottle 18 is not part of the design.

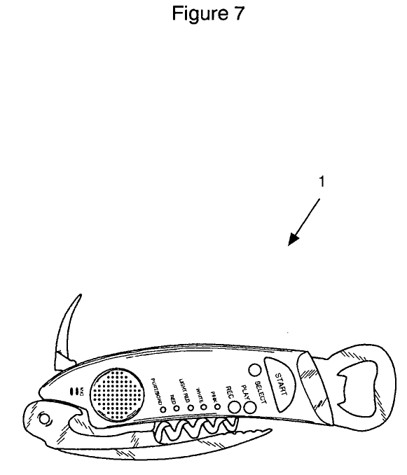

FIG. 7 is a left side view of a preferred embodiment of the corkscrew 1 with Integral Intelligent Thermometer with the corkscrew 1, and the lever arm with integral temperature sensor 2, in the closed position, and the cutting blade in the open position.

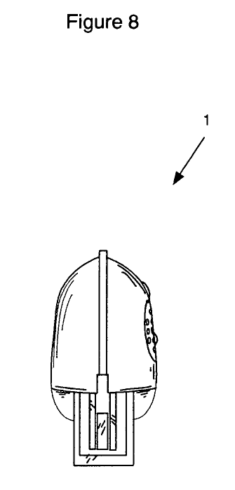

FIG. 8 is a distal end view of a preferred embodiment of the corkscrew with Integral Intelligent Thermometer.

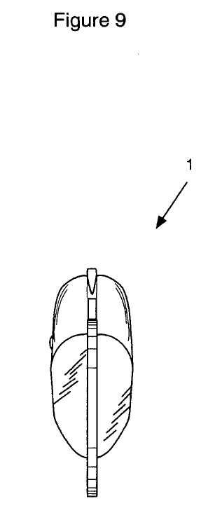

FIG. 9 is a proximal end view of a preferred embodiment of the corkscrew with Integral Intelligent Thermometer.

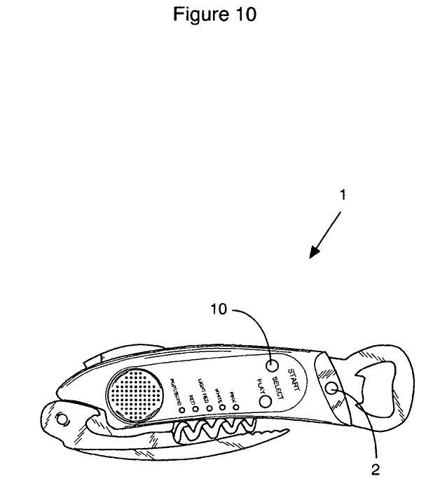

FIG. 10 is a front side view of an alternative preferred embodiment of the corkscrew with Integral Intelligent Thermometer. This embodiment does not have a recording option. In addition, this embodiment also shows an infrared temperature sensor 2 that is mounted on the end of the corkscrew 1. An advantage of this embodiment is that it allows wine temperature to be measured without having the corkscrew 1 come in contact with a bottle. Further, it allows the wine temperature to be measured without breaking the seal of the wine bottle, thereby avoiding any potential degradation to the wine.

The use of infrared technology to measure wine temperature without physical contact with the wine bottle works as follows in regard to the measurement of wine temperature. When the user presses the start button 10, the temperature sensor 2 is activated. By holding a corkscrew 1 toward the body of the wine bottle 18, the temperature of the wine inside the bottle can be measured providing that the IR frequency is properly set. As a result, the user can wait until just the right moment to uncork the wine bottle 18.

Those skilled in the art will recognize that while the temperature sensor 2 is illustrated as an integral component of corkscrew 1, it can also be implemented as a standalone device separate and apart from a corkscrew 1.

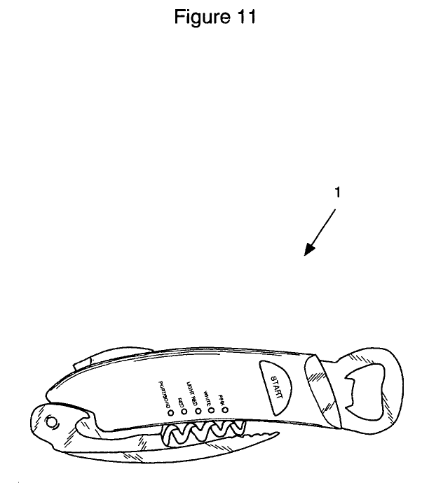

FIG. 11 is a front side view of another alternative preferred embodiment of the corkscrew with Integral Intelligent Thermometer. This embodiment does not have a recording option of a speaker option.

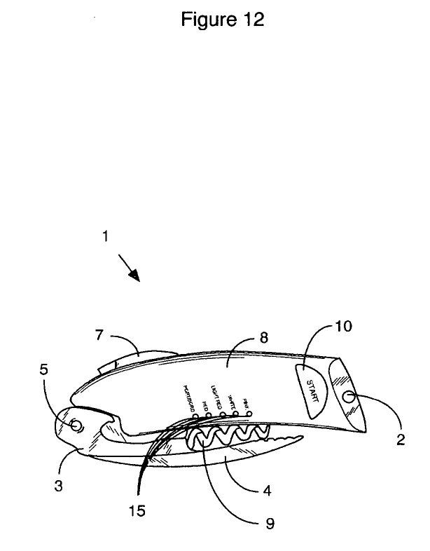

FIG. 12 is a front side view of another alternative embodiment which eliminates the optional audio components, and the optional bottle cap remover 6. The temperature sensor 2 is located on the body of the corkscrew rather than the lever arm 4. Those skilled in the art will recognize that location of the temperature century to as the critical and can be placed in any convenient spot. Likewise, as discussed above regard to the previous embodiments, the temperature sensor 2 can be any suitable technology such as an infrared sensors a thermistor. etc. and.

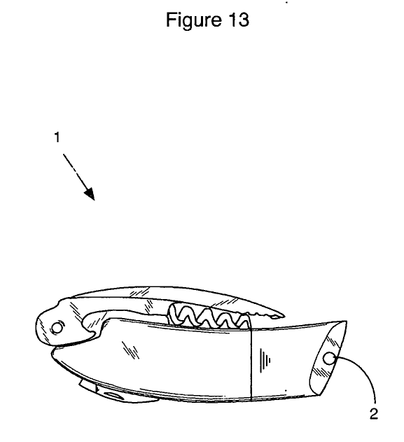

FIG. 13 is a rear side view of the alternative embodiment of FIG. 12 which eliminates the optional magnet 17, and the optional bottle cap remover 6. The temperature sensor 2 is located on the body of the corkscrew rather than the lever arm.

Probe Embodiments

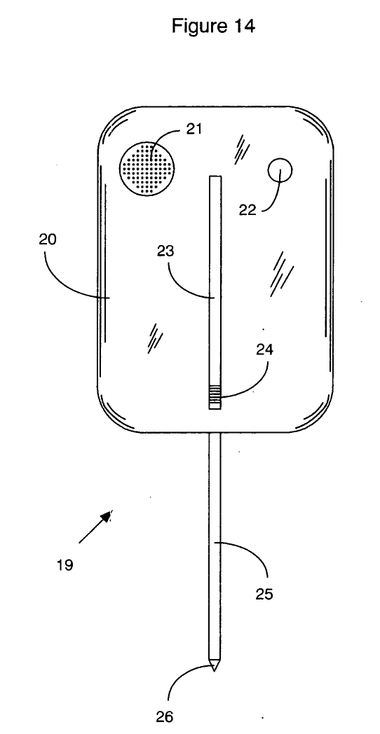

FIG. 14, a preferred embodiment of an intelligent wine temperature probe 19 is illustrated. In this embodiment, the wine temperature probe 19 has an outer case 20. Extending from outer case 20 is a probe 25 which is slideably attached to outer case 20. In this figure, probe 25 is shown fully extended and ready to be inserted into the neck of a wine bottle (not shown) or punctured through the cork. A temperature sensor 26 is shown at the tip of probe 25. Probe 25 is extended from outer case 25 by manually sliding button 24 along track 23. Of course, when wine temperature probe 19 is not being used, the probe 25 is retracted into the outer case 2 by sliding button 24 along track 23 in the opposite direction.

Also shown this figure is speaker 21 and optional microphone 22. Once temperature sensor 26 detects the wine temperature, the value of the sensed temperature is used by control circuitry (not shown) within the outer case 20 to generate output data related to the temperature and output that data on speaker 21. Optional microphone 22 can be used to input voice data or other audio messages for playback under control of the control circuitry.

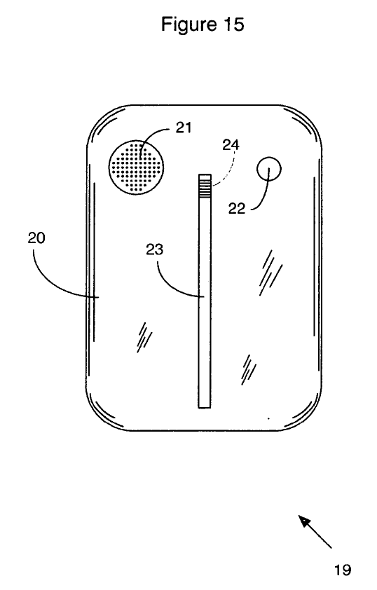

FIG. 15 is a front view of a preferred embodiment of the invention which illustrates an intelligent wine temperature probe 19 with the probe 25 in the retracted position. In this possession, the probe 25 has been retracted entirely within outer case 20. In this position, the probe 25 does not pose any safety hazards, it no longer is at risk of being damaged, it is protected from contamination, and it can now be safely carried in a user's pocket.

Those skilled in the art will recognize that any number of suitable slide mechanisms can be used to move probe 25 into and out of outer case 20. Therefore, the slide mechanism illustrated in FIGS. 14-15 are provided for illustrative purposes only.

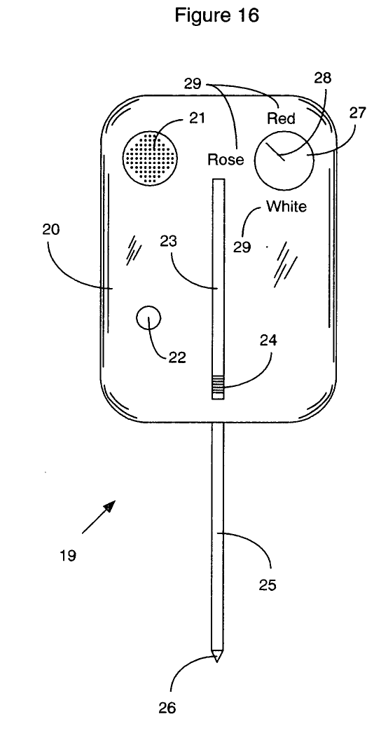

FIG. 16 is a front view of an alternative preferred embodiment of an intelligent wine temperature probe 19 which includes an optional temperature meter 27. Meter 27 is a visual temperature indicator. As temperature increases, the dial 28 moves under control of internal circuitry. Indicia 29 are arranged around the periphery of meter 27 and indicate which wine would be ready to drink at the temperature indicated by dial 28. Those skilled in the art will recognize that the three inidicia shown in this figure are only intended as examples. In practice, any number of wine types can be placed around meter 27. Likewise, the mechanical meter 27 illustrated in this figure can also be implemented as a digital display.

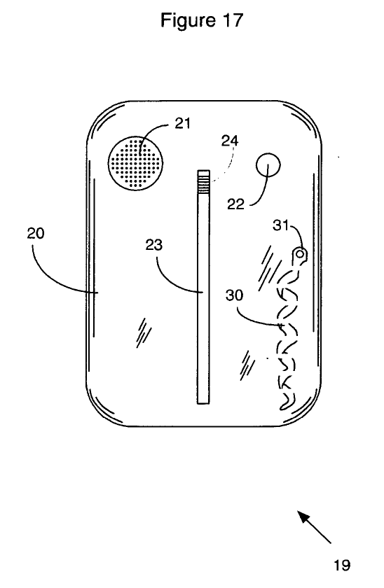

FIG. 17 is a front transparent view which illustrates an alternative preferred embodiment of an intelligent wine temperature probe 19 which includes an optional corkscrew 30 in the retracted position. In this figure, corkscrew 30 is illustrated in dashed lines to indicate that it is folded inside of outer case 20. In this illustration, corkscrew 30 is shown pivotably attached to outer case 20 at pivot 31. Those skilled in the art will recognize that any suitable method of attaching corkscrew 30 to outer case 20 can be used. As was the case with probe 25, corkscrew 30 is intended to be stored within outer case 20 when not in use for the same reasons that probe 25 is stored within outer space 20 not in use.

In this figure, corkscrew 30 was illustrated as a pivoting corkscrew. Those skilled in the art will recognize that corkscrews 30 can also be implemented such that it slides out of the case 20 in the same manner that probe 25 does. In fact, it is possible to implement corkscrew 30 such that probe 25 extends through the spiral of corkscrew 30.

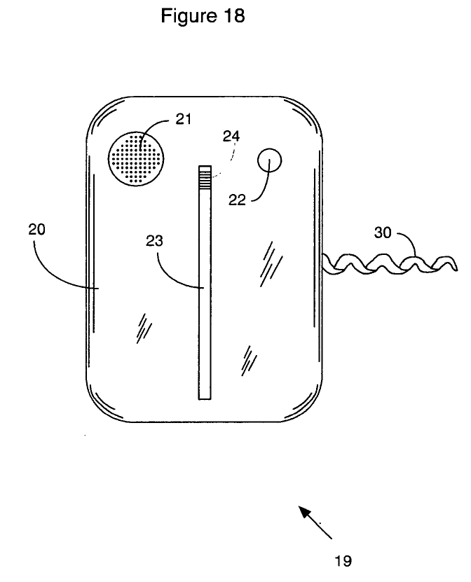

FIG. 18 is a front transparent view which illustrates an alternative preferred embodiment of an intelligent wine temperature probe 19 which includes an optional retractable corkscrew 30 in the extended position.

Other IR Sensor Embodiments

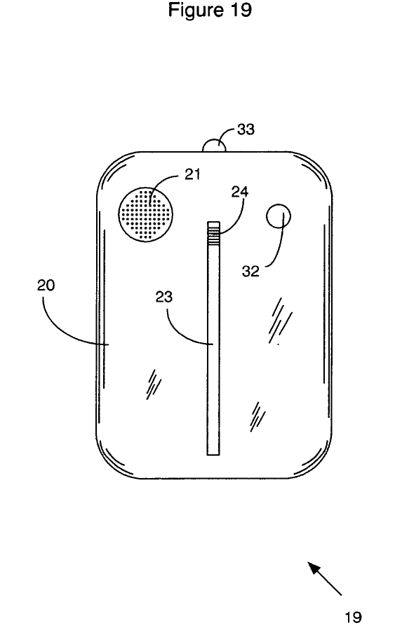

FIG. 19 is a front transparent view of an alternative preferred embodiment of an intelligent wine temperature probe 19 which illustrates an optional infrared temperature sensor 33. In this embodiment, the user can press switch 32 to activate infrared sensor 33. The value of the temperature detected by sensor 33 is input to the control circuitry, which in turn outputs the measurement information via speaker 21.

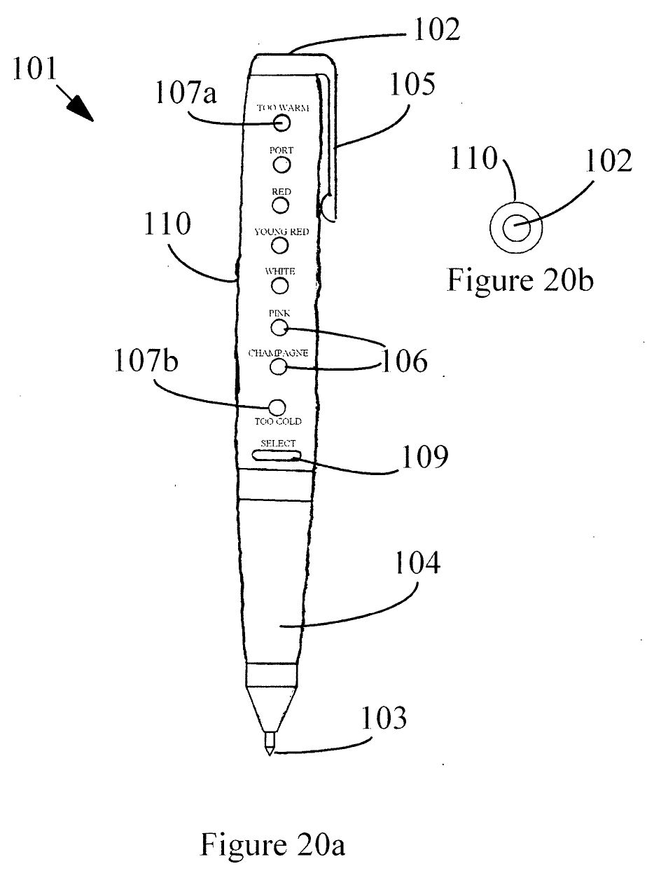

Referring to FIGS. 20a and 20b, this figure shows a front side view of an embodiment of an IR temperature detector 101 in the form of a pen having a casing 110 which has an IR temperature sensor 102 mounted at one end and a writing point 103 mounted at the other FIG. 20b shows a top plan view of the device. The writing point may be permanent, or alternatively, may be retracted and extended by providing a rotatable grip surface 104 that performs this function. The grip surface 104 may be removable from the casing 110 so as to permit refilling of an ink cartridge (not shown) therein. A clip 105 may be provided for carrying in a shirt or jacket pocket.

Mounted in the casing 110 are a plurality of liquid type indicator lamps 106. There may also be provided a pair of temperature indicator lamps 7, a first lamp 107a indicating is a measured temperature is too warm and a second lamp 107b indicating a measured temperature is too cold. A selector control 109 allows the user to select the type of liquid whose temperature the user wishes to measure. For example the selector control 109 may be a simple mechanical button. By repeated pressings of the selector control 109 the circuitry within the detector 101 cycles through the liquid types, causing each liquid type indicator lamp 106 for each liquid type to light up in turn. As shown in the figure, the liquid types may be various types of wine. Such as port, red, young red, white, pink (rose), and champagne. Once the desired liquid type is selected, the user places the IR sensor 102 up against a container holding the liquid of the selected type and waits. The circuitry within the temperature detector 101 notes that the selection control 109 button has not been pressed for a predetermined period of time and activates the IR sensor 102 and calculates the temperature of the liquid in the container based upon the strength of the IR signal detected.

The internal circuitry (not shown) determines whether the measured temperature is within a predetermined range. If so the circuit may indicate this in a number of ways, such as by causing the selected liquid type indicator lamp 106 to flash or by turning on both temperature indicator lamps 7. If, however, the measured temperature is above the preselected temperature range, then the “TOO WARM” lamp 107a is lit. If below the preselected temperature range, then the “TOO COLD” lamp 107b is lit.

Because of space limitations, the circuitry within the infrared liquid temperature detector 101 may utilize multiplexing. To perform multiplexing, it may be desirable to utilize a microcontroller that is capable of both writing and reading data on the same pin. It may also be desirable that the microcontroller have built-in analog-to-digital (A/D) converter capabilities and phase-width-modulation (PWM) capabilities and that the working of the microcontroller be programmable. There are a number of such microcontrollers on the market, such as the PIC16C712 8-bit CMOS microcontroller sold by Microchip Technology, Inc. of Chandler, Arizona. The workings and internal architecture of the PIC16C712 are described in Microchip Technology's datasheet designated DS41106, entitled PIC16C712/716, 8-Bit CMOS Microcontrollers with A/D Converter and Capture/Compare/PWM, published 1999, the disclosures of which are incorporated by reference herein in their entirety.

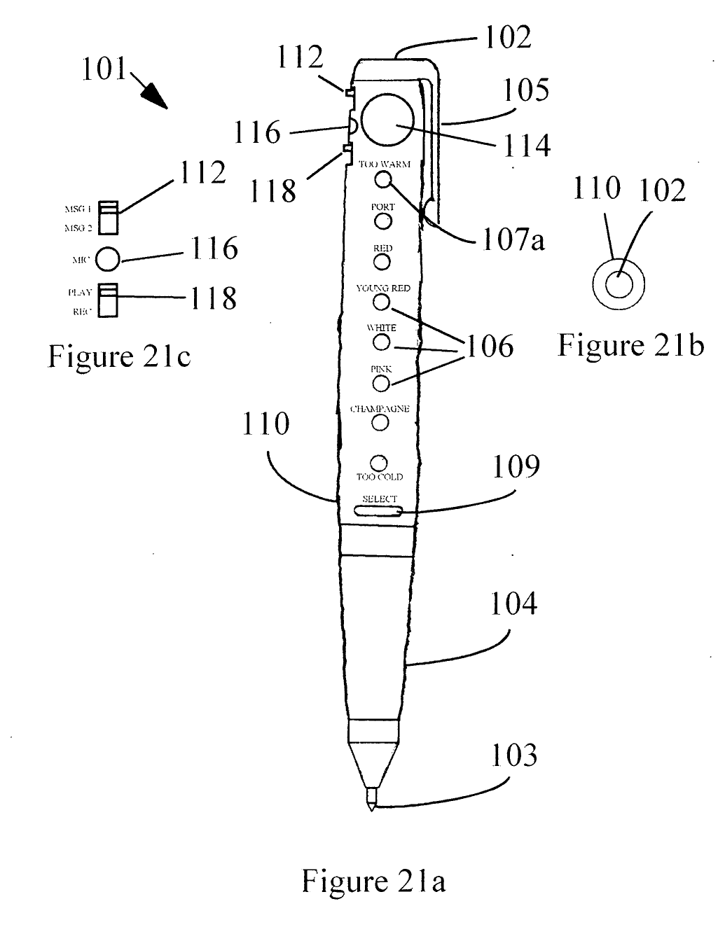

Referring to FIG. 21, there is shown an embodiment of the invention having a speaker 14 that may sound a beep if the measured temperature is within the desired temperature range. Alternatively, the speaker 14 may output a voice message stored in memory. The voice message may be supplied by the manufacturer or may be programmed by the user. In the latter case, a microphone 116 may be provided with a record/play control 118 that may be a slide switch switchable between a play mode and a control mode. Additionally a message control 112 may also be provided to allow the user to store more than one message. For example, if the measured temperature is within range, a voice message saying something such as “Your wine has reached optimal drinking temperature” or “Now ready to be served” may be broadcast through the speaker 14.

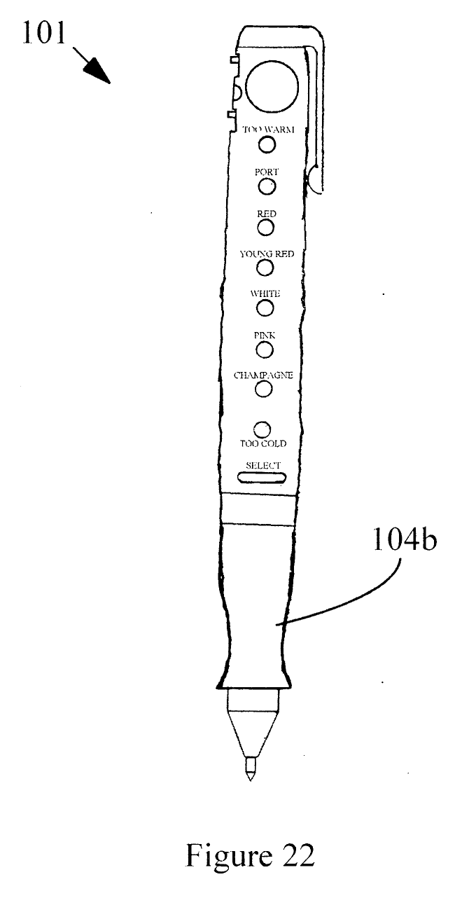

Referring to FIG. 22, there is shown an embodiment utilizing a no-slip grip 104b as are becoming increasingly popular of late. The shape of these grips prevent the fingers from sliding down the pen when downward pressure on the pen is applied during writing. This may be particularly useful for those in the restaurant business who may have slippery oils or fats on their fingers when writing.

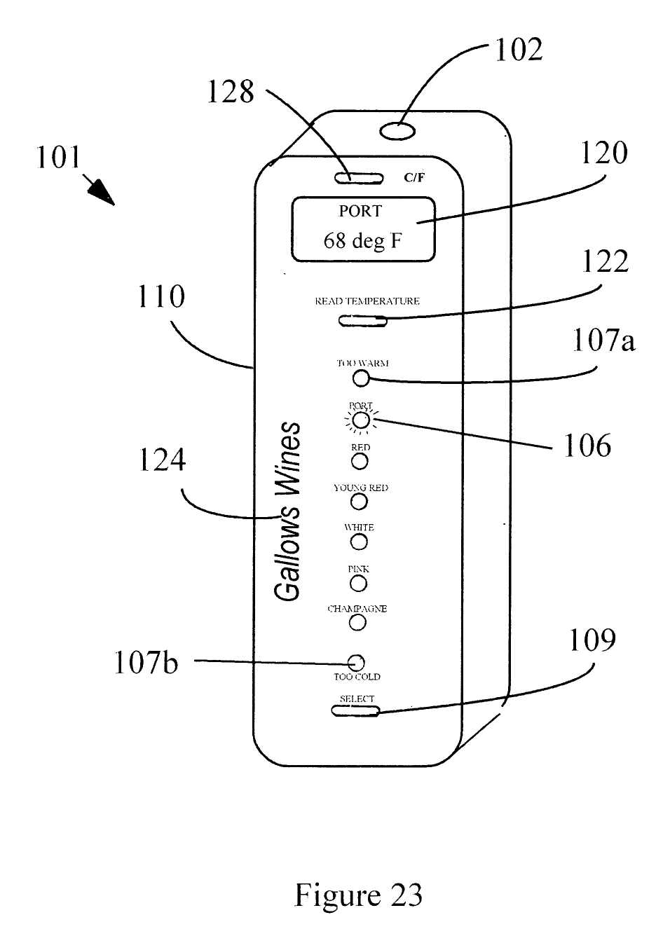

Referring to FIG. 23, there is shown a rectangular wand embodiment of the invention. By “wand” meaning an elongate casing 110 with no pen capability, though a pen could certainly be added. Again, the infrared sensor 102 is located on a first end of the casing 110.

Three additional optional features are shown here, which may or may not be utilized on any of the embodiments of FIGS. 20 through 24. First, a liquid crystal display (LCD) 120 that shows the actual temperature measured. If using such a display, a Centigrade/Fahrenheit switch 28 may be provided to switch the display between Centigrade and Fahrenheit.

Secondly a read temperature control 122 may be provided to initiate the temperature reading procedure. Hence the user may first select the liquid type using the select control 109, but the device will not begin taking a reading until the read temperature control 122 is activated. The display may also shown the selected liquid to verify that the microcontroller is comparing the measured temperature to the selected temperature range. In the Figure, for example, the user has selected port wine, so the liquid type lamp 106 for port is lit and the LCD display 120 verifies this by displaying the word “PORT.”

Thirdly, the IR liquid temperature may be customized for a particular customer by imprinting the customer's logo or other customer identifying information 124 upon the casing 110.

If desired, the speak and microphone capabilities of FIG. 21 may also be added to this embodiment.

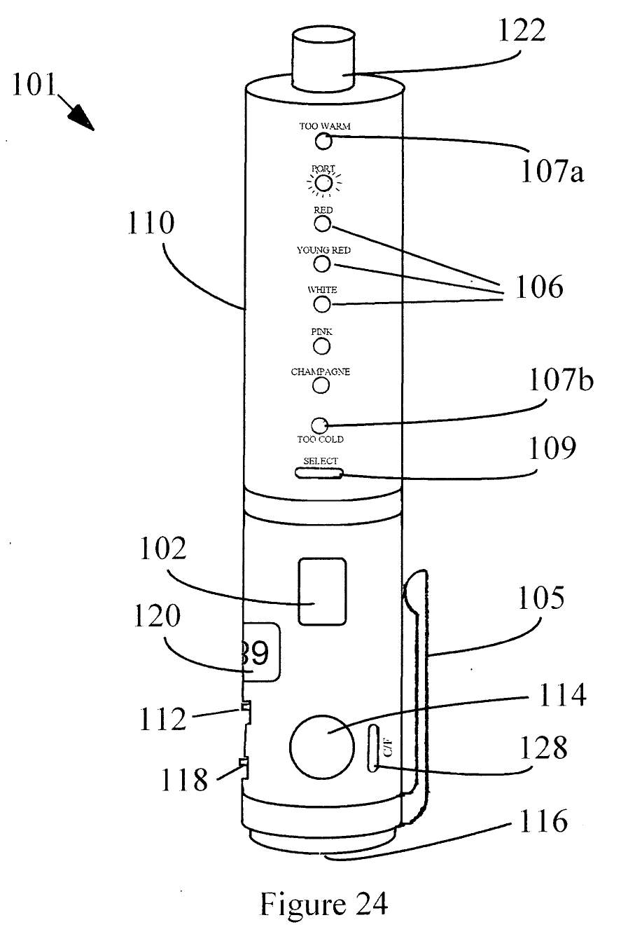

Referring to FIG. 24, there is shown a wand embodiment of the invention with the IR sensor 102 mounted on the side of the casing 110 allowing a first end of the casing 110 to receive the read temperature control 122, here in the form of a push button, and upon a second end of the casing 110 to be mounted the microphone 116. Alternatively, this wand can be made into a pen by mounting a writing point on the second end of the casing 110 and side-mounting the microphone 116. Note that the type of wine selected is omitted from the display 120 to allow larger temperature numbers to be displayed. The display 120 is also mounted on the casing 110 at an angle of about 90 to 180 degrees to the IR sensor 102 so the display 120 can be seen and read by the user when the IR sensor 102 is up against the bottle. The number “68” is shown inverted on the display in the drawing because the read temperature control 122 button is at the top of the drawing, so it is from this vantage that the user would be seeing the display 120.

The other numbered components shown are as described with respect to the previous FIGS. 20 through 23.

Note that one may include more controls to effectuate a number of measuring schemes. For example, certain foods must be stored at certain temperatures. Generally, to keep within Food and Drug Administration (FDA) guidelines, foods must be discarded if they fall within certain critical temperature ranges for more than four hours. These ranges are, for ground beef: 92 deg. F to 106 deg. F.; for chicken: 77 deg F. to 170 deg. F.; for eggs: 74 deg. F. to 165 deg. F., for leftovers: 74 deg. F. to 165 deg. F.

As an option, particularly attractive to restaurateurs, one may include a menu button to switch from wine temperature ranges to food temperature ranges. Another click of a menu button could reveal a straight digital readout of temperature in Celsius and/or Fahrenheit. Various such menu options are available with an LCD display.

Additional Corkscrew Embodiments

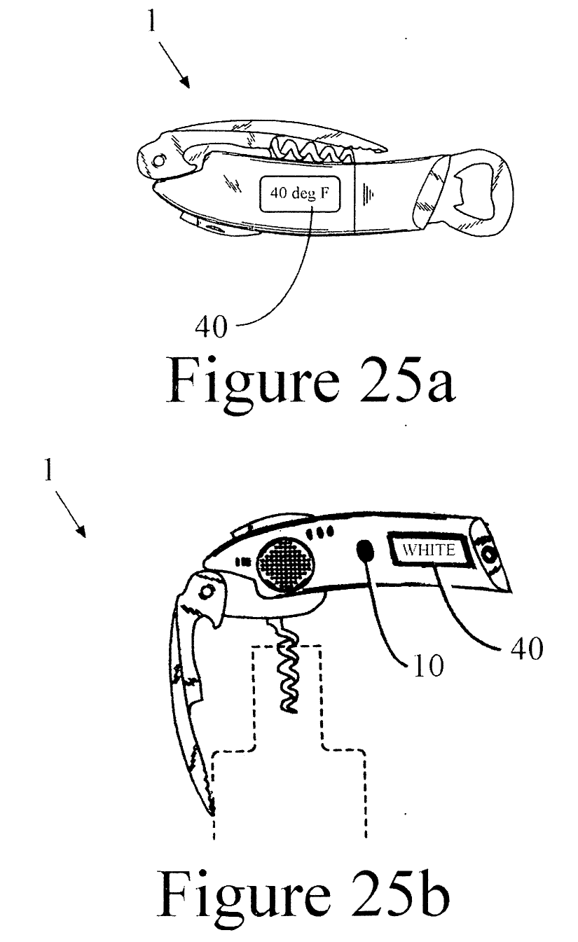

Referring to FIG. 25a, there is shown an additional corkscrew embodiment in which the magnet 17 of FIG. 2 is replaced with a digital temperature readout display 40, such as an LCD display. Of course, if the corkscrew 1 is large enough both a magnet 7 and a display may be fitted on one side. Alternatively, as shown in FIG. 25b, the digital display may be mounted on the other side of the corkscrew as an alternative to or addition to the speaker 16 of FIG. 1. Alternatively, the speaker 16 could be mounted next to the magnet 7 so as to allow for the digital display 40 on one side and both magnet 17 and speaker 16 on the other.

Note that the digital display 40 need not only display temperature, but may be used to display the type of wine being tested for. Hence, the LED indicators 15 of FIG. 1 may be dispensed with. The user would select a wine-type that appears on the LCD display and then press the start button 10. When the temperature is measured, the wine-type on the LCD display is replaced by either an actual measured temperature, or an indication that the wine is too hot, too cold, or just right.

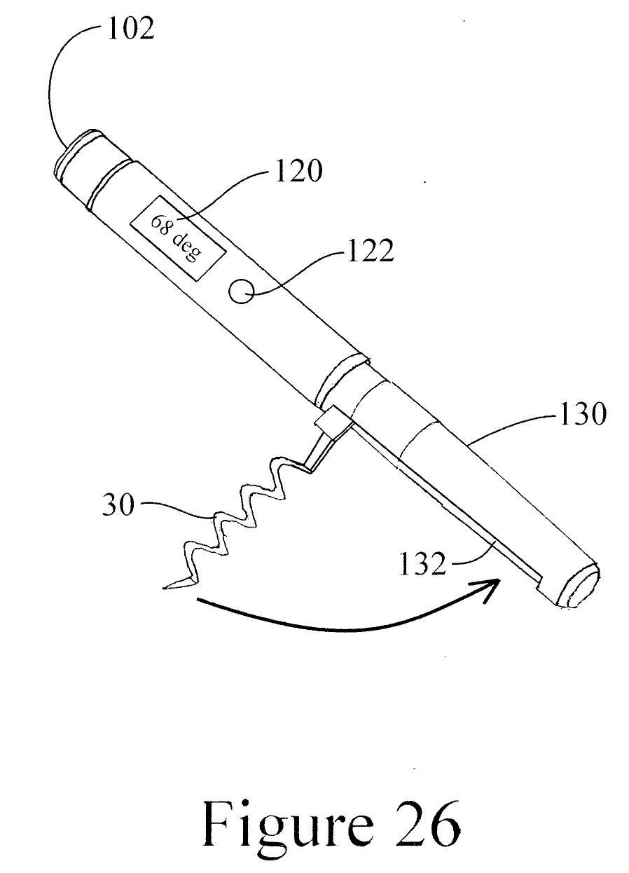

Referring to FIG. 26, there is shown another wand embodiment of the invention having a corkscrew 30 integrated therein. This corkscrew wand embodiment may have the IR detector 102 mounted on the end or side as desired, here shown on an end of the device. As described for previous embodiments, a display 120 and one or more controls 122 are provided. At another end of the device is provided an extension 130 such that the entire device forms a “T” shape with respect to the corkscrew 30, thereby creating a handle for twisting the corkscrew into a cork. In a preferred embodiment, the extension further comprises a slot 132 such that the corkscrew 30 may be pivoted into the extension when not is use as show by the directional arrow in the figure.

While various values, scalar and otherwise, may be disclosed herein, it is to be understood that these are not exact values, but rather to be interpreted as “about” such values, unless explicitly stated otherwise. Further, the use of a modifier such as “about” or “approximately” in this specification with respect to any value is not to imply that the absence of such a modifier with respect to another value indicates that other value to be exact.

Changes and modifications can be made by those skilled in the art to the embodiments as disclosed herein and such examples, illustrations, and theories are for explanatory purposes and are not intended to limit the scope of the claims. Further, the abstract of this disclosure is provided for the sole purpose of complying with the rules requiring an abstract so as to allow a searcher or other reader to quickly ascertain the subject matter of the disclosures contained herein and is submitted with the express understanding that it will not be used to interpret or to limit the scope or the meaning of the claims.

What is claimed is:

1. A method of measuring the temperature of a liquid within a container, comprising the steps of:
placing an infrared sensor in close proximity to an outer wall of the container;
measuring the levels of infrared radiation emitted from, transmitted through, and re-emitted from the outer wall of the container.

2. The method of claim 1 wherein the container is glass.

3. The method of claim 2 wherein the container is plastic.

4. The method of claim 1 wherein the liquid is a beverage.

5. The method of claim 4 wherein the liquid is an alcoholic beverage.

6. The method of claim 5 wherein the beverage is a wine.

7. The method of claim 1 wherein the infrared sensor is integrated into a corkscrew.

8. The method of claim 1 wherein the infrared sensor is integrated into a bottle opener.

9. An intelligent wine temperature probe for use with wine bottles, comprising:
an external case, further comprising:
temperature indication output means;
an internal cavity:
a retractable wine temperature probe, the retractable wine temperature probe sized such that it fits within the internal cavity, and slideably attached to the external case such that it can be extended outside of the external case or retracted into the external case;
the retractable wine temperature probe further capable of being inserted into the neck of a wine bottle;
a temperature sensor in the wine temperature probe;
means to output the temperature detected by the temperature sensor; and
whereby the wine temperature probe outputs information related to the temperature of wine inside the bottle.

10. The apparatus of claim 9 wherein the probe is of sufficient sharpness to penetrate a cork disposed in the neck of the bottle.

11. The apparatus of claim 9 further comprising a corkscrew.

12. The apparatus of claim 10 further comprising a corkscrew.

13. The apparatus of claim 12 wherein the probe is a corkscrew.

14. An apparatus for measuring the temperature of a liquid in a container, comprising:
an elongate casing having an infrared detector mounted thereon and so positioned so as to be capable of being brought in contact with the container;
an infrared detector;
an output indicating to the user indicating the measured temperature.

15. The apparatus of claim 14 further comprising a plurality of indicator lamps, each lamp representing a particular type of liquid;

16. The apparatus of claim 14 further comprising a control for selecting the type of liquid whose temperature is to be measured;

17. The apparatus of claim 14 further comprising a penpoint.

18. The apparatus of claim 14 further comprising an LCD display.

19. The apparatus of claim 14 further comprising an audio output.

20. The apparatus of claim 14 further comprising a menu option to measure food temperatures.

21. The apparatus of claim 16 further comprising a menu option to display a digital numeric readout of the measured temperature.

22. The method of claim 7 wherein the measured temperature is displayed by a digital display.

23. The apparatus of claim 14 further comprising an extension portion forming a “T” configuration with a corkscrew.

24. The apparatus of claim 23 wherein the corkscrew and extension portion are adapted such that the corkscrew may be retracted into the extension.
